(19) United States
(12) Patent Application Publication
(10) Pub. No.: US 2016/0049269 A1
(43) Pub. Date: Feb. 18, 2016

(54) DISCONNECTING SWITCH UNIT

(71) Applicant: SIEMENS AKTIENGESELLSCHAFT, München (DE)

(72) Inventors: JOERG GORABLENKOW, BERLIN (DE); IVAN HASNEK, BERLIN (DE); CHRISTIAN WALLNER, ERLANGEN (DE)

(21) Appl. No.: 14/782,160

(22) PCT Filed: Mar. 24, 2014
(86) PCT No.: PCT/EP2014/055832

§ 371 Date: Oct. 2, 2015

(30) Foreign Application Priority Data
Apr. 4, 2013 (DE) 10 2013 205 945.0

(51) Int. Cl. H01H 33/91; H01H 33/92

(52) U.S. Cl. CPC H01H 33/91; H01H 33/92

(57) ABSTRACT

A disconnecting switch unit or isolating switching device includes a first contact piece and a second contact piece which are movable relative to each other and between which a disconnection or isolation zone is formed when the pieces are separate. A compression device has a compression chamber accommodating a fluid. The compression chamber protrudes at least temporarily into the disconnection or isolation zone.

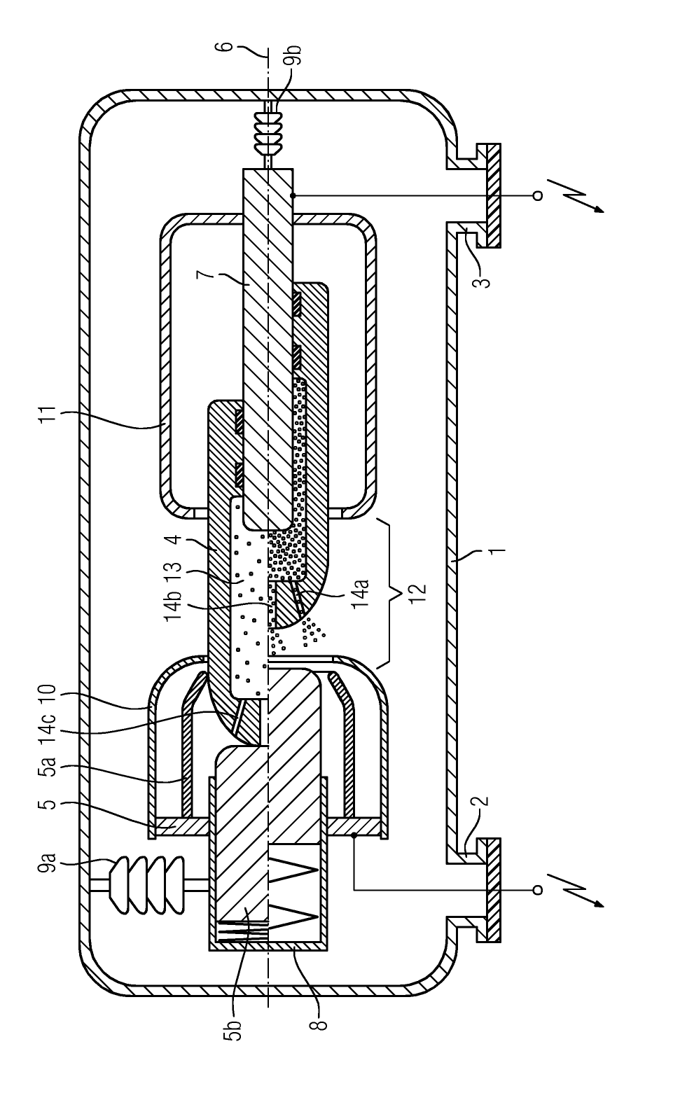

The invention relates to an isolating switching device comprising a first contact piece and comprising a second contact piece, which are movable relative to one another and can be isolated in an isolation zone, and comprising a compression device, which has a compression space for accommodating a fluid.

Such an isolating switching device is known, for example, from the US patent U.S. Pat. No. 4,829,150. Said document describes an isolating switching device comprising a first contact piece and a second contact piece. The two contact pieces are arranged so as to be moveable relative to one another. The two known contact pieces can be isolated from one another in an isolation zone. Furthermore, the isolating switching device has a compression device, which comprises a compression space for accommodating a fluid. One of the contact pieces passes through the compression space of the compression device, with the result that fluid compressed within the compression space is directed past the contact piece into the isolation zone. In order to produce a sufficient flow in the region of the isolation zone, the known compression space is designed to have a comparatively large volume. Owing to the large volume of the compression space, high drive forces are required for actuating the compression device.

This results in the object of specifying an isolating switching device which can produce a sufficient fluid flow with a reduced consumption of energy for compressing the fluid.

In accordance with the invention, this object is achieved in the case of an isolating switching device of the type mentioned at the outset by virtue of the fact that the first contact piece has at least one outflow opening for the emergence of fluid compressed in the compression space.

An isolating switching device is, for example, a device which is used for de energized opening of a current path. Even in the event of de energized opening of a current path, discharge phenomena may occur at contact pieces which are movable relative to one another. Such discharge phenomena are fed, for example by residual charges, to lines or busbars, with the result that, in the event of isolation of the contact pieces from one another, arc phenomena can arise between said contact pieces. Producing a flow of a fluid in the isolation zone of the isolating switching device makes it possible to blow arcs occurring and cool the isolation zone or clear it of impurities. Suitable fluids are, for example, electrically insulating fluids which fill the isolation zone extending between the contact pieces or around the contact pieces. Suitable electrically insulating fluids are in particular electrically insulating gases, such as, for example, sulfur hexafluoride, nitrogen or carbon dioxide. However, provision can also be made for liquid media such as insulating oils or insulating esters to be used as fluid, for example. The isolation zone is the space in which contact-making/isolation of the contact pieces which are movable relative to one another takes place. The isolation zone is filled with an electrically insulating fluid, with the result that contact pieces which can conduct different electrical potentials are electrically insulated from one another. Thus, in the isolation zone, an isolation point can be arranged in order to isolate, for example, different devices of an electrical energy transmission device from one another. Thus, for example, cables can be isolated from circuit breakers via the isolating switching device.

In order to produce a fluid flow, for example, a compression device comprising a compression space can be used. The compression space can in this case have a variety of configurations. The compression space can be in the form of a variable-volume element, for example, with the result that in the event of a reduction in the volume of the compression space, a compression of a quantity of fluid which is enclosed within the compression space takes place. Such a mechanical compression volume can be in the form of a piston/cylinder arrangement, for example. Furthermore, the compression device can also have a constant-volume compression space, into which quantities of fluid are forced, as a result of which the fluid to be accommodated in the compression volume undergoes a pressure increase.

If the first contact piece is used for guiding and directing a fluid flow into the isolation zone, the installation space available can be reduced. In particular in the contact-making region of the first contact piece, i.e. the region which is used for galvanic contact-making or is moved into the direct vicinity of the second contact piece, high field intensities occur. Thus, the first contact piece can be provided with at least one outflow opening, which allows the compressed fluid to emerge into the isolation zone. The outflow opening can be a mouth of an outflow channel which connects the compression space to the outflow opening. For this purpose, the contact piece can have, for example, at least one outflow channel, which conducts the compressed fluid out of the compression space into the region of the isolation zone. By virtue of the arrangement of the outflow opening directly at the first contact piece, the possibility is provided of directing the compressed fluid efficiently into the regions in which the occurrence of discharge phenomena is most likely. This avoids the possibility of dielectrically stable regions unnecessarily being flushed by a fluid flow. Thus, the total volume which needs to be subjected to excess pressure within the compression space can be reduced. Correspondingly, more effective use of the fluid compressed in the compression space is provided. For example, a plurality of outlet openings can be arranged at various positions on the first contact piece. In particular, an outflow opening can be arranged in the contact-making region of the first contact piece. Thus, for example, directly after isolation of contact between the first and second contact pieces, this is detected at this point in time as a region of a fluid flow which should be considered to be dielectrically critical. For this, a plurality of outflow openings can effect, for example, a jet-shaped emergence of the fluid into the isolation zone. By virtue of efficient distribution and targeted emergence of the fluid compressed in the compression space, the total volume which is required for blowing the isolation zone is reduced. Correspondingly, less energy is required in order to effect compression of the fluid.

Furthermore, provision can advantageously be made for the compression space to at least temporarily protrude at least partially into the isolation zone.

The compression space protruding at least temporarily into the isolation zone makes it possible to keep the outflow channels which can be positioned on the first contact piece for directing and conducting the fluid compressed in the compression space in the direction of the outflow opening(s) comparatively short. If the compression space is now brought into the isolation zone, the required volume can be compressed directly in the region in which it is intended for the outflow. Therefore, in particular friction losses in outflow channels are avoided, which friction losses would occur in order to bring the fluid provided for the outflow from remote compression spaces into the region of the isolation zone. Correspondingly, this measure results in, firstly, the possibility of reducing the volume available for the outflow. Secondly, owing to the reduced friction losses, excessive pressure build up in the compression space can be dispensed with. Thus, energy which needs to be expended in this case for the compression is reduced. Since the excess pressure within the compression space can also be reduced, reduced moved masses at the compression device which can be moved with reduced consumption of energy also result from possible wall thickness reductions.

Advantageously, provision can be made for the compression space to be moved into the isolation zone and out of the isolation zone corresponding to a relative movement of the contact pieces relative to one another. In particular, the compression space can be moved together with a movable contact piece. If a compression device whose compression space at least temporarily extends within the isolation zone is now used, it is possible to perform compression of the fluid directly in the region in which an outflow of the fluid is also desired. Thus, long transmission paths which lead to additional friction losses in the compressed fluid are avoided. Correspondingly, the volume of fluid to be compressed can be reduced since this can emerge and pass over directly into the isolation zone with low losses. Advantageously, in this case it should be endeavored to achieve protrusion of the compression space into the isolation zone during the switched-on state. Conversely, preferably the compression space should be removed from the isolation zone in the isolated position of the isolating switching device.

For example, one or both contact pieces can be moved by means of a drive device, with the result that an insulation path between the contact pieces can be produced within the isolation zone, i.e. the distance between said contact pieces is enlarged. For contact-making, the contact pieces are brought closer to one another in the isolation zone. For example, the first contact piece can be shaped in the form of a bolt, whereas the second contact piece can be in the form of a bush, into which the mirror-inverted bolt-shaped first contact piece can be inserted.

The two contact pieces have each been brought into electrical contact with further phase conductor sections, with the result that a current path can be interrupted via an isolation point.

A further advantageous configuration can provide for the compression space to be at least partially delimited, in particular encompassed, by the first contact piece.

The first contact piece can be configured so as to be movable, for example, and can be moved, driven by a drive device, into the isolation zone or out of the isolation zone. If this first contact piece is now used for delimiting the compression space, it is easily possible to effect a compression of a fluid in the direct vicinity of the isolation zone or within the isolation zone. The first contact piece can thus firstly be used for current transmission or current conduction, and secondly this contact piece can represent a barrier for delimiting the compression space. Advantageously, the compression space should be encompassed by the first contact piece. It is thus possible, for example, to arrange the compression space at least sectionally within the first contact piece, with the result that said compression space is dielectrically shielded by the first contact piece. Thus, the compression space can be moved together with the first contact piece. The first contact piece can have, for example, a cylinder cutout for delimiting the compression space, into which a piston can enter. Equivalently, the first contact piece can, for example in the manner of a piston, enter a cylinder cutout and delimit the compression space. A common movement at least of sections of the compression space makes it possible for the isolation zone in the isolated position of the two contact pieces to be kept free from a protruding compression space. Furthermore, such a design has the advantage that at one or more points on the first contact piece, for example, at least one outflow opening can be positioned, with the result that fluid compressed in the compression space can flow out of the compression space and flow into the isolation zone via the outflow opening. It is thus possible, for example, to provide different outflow openings at the first contact piece in order to bring about various directions of flow or to subject the isolation zone to flow from different directions.

Furthermore, provision can advantageously be made for an outflow opening for fluid compressed in the compression space to be arranged in a contact-making region of the first contact piece.

An outflow opening can be arranged, for example, in the contact-making region of the first contact piece. The contact-making region of a contact piece is the region in which galvanic contact-making with another contact piece is provided. A contact-making region of a contact piece is, for example, the region in which the contact pieces overlap one another. This region can be regarded as being subjected to a particular dielectric load since, in this case, the contact pieces approach one another or move away from one another, wherein the contact pieces can have electrical potentials which are different than one another. Correspondingly, increased dielectric loading can occur at the mutually facing regions, in particular at contact-making regions both of the first contact piece and of the second contact piece. An arrangement of the outflow opening within a contact-making region of the first contact piece makes it possible to bring about a flow of electrically insulating fluid flowing out of the compression space within the dielectrically loaded regions with the greatest of care since, in particular in this region, the occurrence of arcs is to be expected owing to increased electrical field intensities. Thus, an arc being struck can be blown and cooled as early as the time at which it is produced.

A further advantageous configuration can provide for the first contact piece to act as cylinder or as piston for a piston or cylinder which is movable relative to the first contact piece.

A configuration of the first contact piece as cylinder makes it possible to use a cylinder space of the first contact piece for delimiting the compression space. For the change in volume, for example, a piston can protrude into the cylinder space, wherein the piston is arranged movably relative to the first contact piece. Advantageously, the piston should be positioned fixed in location, with the result that the first contact piece is arranged in sliding fashion on the piston. Thus, the piston base of the piston, together with the cylinder space of the first contact piece, can delimit the compression space of the compression device. Advantageously, in this case the piston should be formed as part of the current path which can be interrupted by the isolating switching device. Thus, a sliding contact arrangement can preferably be formed between the piston and the cylinder. Equivalently, a formation of the first contact piece as a piston can also be provided, conversely, wherein the first contact piece can enter a cylinder space.

Advantageously, provision can be made for the second contact piece to have a preliminary contact section and a main contact section.

Providing the second switching contact piece with a preliminary contact section and a main contact section makes it possible to guide an arc preferably in a specific section of the second switching contact piece. The preliminary contact section makes contact with the first switching contact piece temporally prior to contact at the main contact section of the second switching contact piece. For example, provision can be made for the main contact section to be in the form of a bush, wherein the preliminary contact section is an axially displaceable element which is placed within a bush opening. Thus, it is possible, for example, for the preliminary contact section to be used firstly for making contact temporally in advance, and secondly the preliminary contact section can also, however, dielectrically shield the bush opening of the second switching contact piece and thus intensify the dielectric strength of the isolation zone. In the event of a switch-off operation, first the main contact section is released by the first contact piece and then isolation of the preliminary contact section from the first contact piece is performed. Correspondingly, arcs preferably occur at the preliminary contact section. It is therefore advantageous to allow compressed fluid to emerge in particular in the direction of the preliminary contact section.

Furthermore, provision can advantageously be made for the preliminary contact section and the main contact section to be movable relative to one another.

The preliminary contact section can be mounted so as to be relatively displaceable with respect to the main contact section of the second contact piece. This provides the possibility of spring-loaded contact between the preliminary contact section and the first contact piece and the main contact section and the first contact piece, independently of one another. In the event of a switch-off operation, commutation of a switch-off current from the main contact section to the preliminary contact section is possible. The preliminary contact section can in this case protect the main contact section from arc erosion.

A further advantageous configuration can provide for fluid compressed in the compression space to flow out of the compression space during a switch-off operation.

Advantageously, compression of a fluid in the compression space should take place during or prior to the onset of a switch-off operation, with the result that, over the course of a switch-off operation, a sufficient volume of increased-pressure fluid is kept available within the compression space, which fluid can flow through an outflow opening into the isolation zone. In particular in the event of continuous compression of the fluid over the course of a switch-off operation, a continuous outflow of the compressed fluid through the outflow opening can be enforced. Correspondingly, retaining fluid at elevated pressure in the run up to a switch-off operation is not necessary. An outflow of fluid can begin as early as during an onset of the switch-off operation and last at least continuously during the presence of a relative movement of the contact pieces in relation to one another over the course of a switch-off operation. Correspondingly, contaminants can be flushed from the isolation zone. The isolation zone is cooled and flushed. Thus, quenching of arcs in the isolation zone is assisted.

An exemplary embodiment of the invention will be shown schematically in a drawing and described in more detail below.

In the drawing

The FIGURE shows a section through an isolating switching device.

The isolating switching device has an encapsulating housing 1. The encapsulating housing 1 in this case has a metallic basic body. An accommodating area is arranged in the interior of the encapsulating housing 1. The encapsulating housing 1 acts as a barrier, with the result that fluid arranged in the accommodating area in the interior of the encapsulating housing 1 cannot emerge from the encapsulating housing 1. The fluid enclosed in the accommodating area is sealed off from the surrounding environment in hermetically seal tight fashion. Preferably, the fluid enclosed in the accommodating area has an electrically insulating effect and is subject to an excess pressure, with the result that its dielectric strength is increased. Suitable electrically insulating fluids are, for example, gaseous sulfur hexafluoride, gaseous carbon dioxide or gaseous nitrogen. Furthermore, liquid fluids can also be used. In this case, for example, insulating oils or insulating esters can be used.

In order to make contact with the electrically active parts of the isolating switching device arranged in the accommodating area, the encapsulating housing 1 has a first flange lead through 2 and a second flange lead through 3. The two flange lead through 2, 3 each have a flange, which is sealed in fluid-tight fashion by an electrically insulating lead through insulator. A phase conductor section passes in fluid-tight fashion through each of the lead through insulators, said phase conductor sections leading out of the surrounding environment of the encapsulating housing 1 into the interior of the accommodating area.

A first contact piece 4 and a second contact piece 5 are arranged in the accommodating area. The two contact pieces 4, 5 are movable relative to one another. In this case, the first contact piece 4 is in the form of a bolt and is mounted displaceably along a longitudinal axis 6. The second contact piece 5 is in the form of a bush, wherein a bush opening is formed in such a way that the first contact piece 4 with its contact-making region can be inserted into the bush opening in the second contact piece 5. The second contact piece 5 is in this case divided into a main contact section 5a, which surrounds the bush opening on the outer lateral surface side, and a preliminary contact section 5b, which, surrounded by the main contact section 5a, is mounted displaceably in the bush opening in the second contact piece 5. A first guide unit 7 is assigned to the first contact piece 5, said first guide unit serving to guide and conduct the first contact piece 4. Furthermore, the first guide unit 7 is used for making electrical contact between the first contact piece 4 and a phase conductor section, which is passed through the second flange lead through 3 into the surrounding environment of the encapsulating housing 1. Similarly, the second contact piece 5 has a second guide unit 8, which is used for positioning the second contact piece 5. Furthermore, the second guide unit 8 is also used for making contact between the second contact piece 5 and a phase conductor section, which is passed through the first flange lead through 2 into the surrounding environment of the encapsulating housing 1. The two guide units 7, 8 are supported on the inner lateral surface side on the encapsulating housing 1 via electrically insulating supporting arrangements 9a, 9b. The preliminary contact section 5b of the second contact piece 5 is mounted displaceably on the second guide unit 8 in the direction of the longitudinal axis 6.

In this case, the preliminary contact unit 5b is mounted spring-loaded in the direction of the first contact piece 4 in the second guide unit 8, wherein, in the open state of the isolating switching device, the preliminary contact section 5b blocks the bush opening in the second contact piece 5 to large parts and dielectrically shields said bush opening. In supplementary fashion, a shielding hood 10 is arranged on the second guide unit 8, which shielding hood dielectrically shields the second contact piece 5. Similarly, a further shielding hood 11 is fastened on the first guide unit 7, said further shielding hood dielectrically shielding the first guide unit 7 and the first contact piece 4. On mutually facing sides of the further shielding hood 11 and the shielding hood 10, the shielding hoods 10, 11 each have cutouts, via which access to the first and second contact pieces 4, 5, respectively, is possible. An isolation zone 12 of the isolating switching device extends between the two shielding hoods 10, 11 or between the two contact pieces 4, 5 and, in the state in which contact is made, around the two contact pieces 4, 5. The isolation zone 12 is the region in which the formation of an electrically insulating path between the first contact piece 4 and the second contact piece 5 is possible. This electrically insulating path is also referred to as switching path. In the isolation zone 12, in the event of an opening operation, an arc can form, for example as a result of charged lines which are connected to the phase conductor sections passing through the flange lead throughs 2, 3. Advantageously, the electrically insulating fluid is flushed through the isolation zone 12, wherein, during a switch-off operation, a flow of outflowing fluid through the isolation zone 12 should be brought about in a targeted manner.

In the open state, the isolation zone 12 extends between the mutually facing regions of the first and second contact pieces 4, 5. The first contact piece 4 is in this case at least sectionally hollow-cylindrical, with the result that the first contact piece 5 can be mounted in sliding fashion on the first guide unit 7. The first guide unit 7 in this case acts as piston, which, in the event of a movement of the first contact piece 4, enters the cylinder cutout in the first contact piece 4 and moves out of said cylinder cutout. Correspondingly, the first guide unit 7 is in the form of a piston, whereas the first contact piece 4 is in the form of a cylinder. The cylinder cutout in the first contact piece 4 thus acts as compression space 13, which has a variable volume. The compression space 13 is filled with the fluid enclosed in the interior of the encapsulating housing 1. Outflow channels 14a, 14b, 14c are arranged in the first contact piece 4. The outflow channels 14a, 14b, 14c are in this case aligned radially with respect to the longitudinal axis 6. The outflow channels 14a, 14b, 14c open out on one side into the compression space 13. On the other side, the outflow channels 14a, 14b, 14c have in each case at least one outflow opening in a contact-making region of the first contact piece 4.

In the closed state of the isolating switching device, the first and second contact pieces 4, 5 are in galvanic contact with one another. The compression space 13 has its largest volume (cf. FIGURE above the longitudinal axis 6). Within the compression space 13, the fluid enclosed there is at present substantially with the same steady-state pressure as the further fluid enclosed within the encapsulating housing 1. Over the course of a movement of the first contact piece 4 by a drive device (not illustrated in the FIGURE), the first contact piece 4 is removed from the second contact piece 5 (cf. FIGURE below the longitudinal axis 6). In this case, the piston-like first guide element 7 is moved relative to the first contact piece 4 with the result that the volume of the compression space 13 is reduced. The fluid enclosed within the compression space 13 is in this case subjected to an excess pressure since the cross section of the outflow channels 14a, 14b, 14c/the mouths is insufficient for compensating for the reduction in volume of the compression space 13 in good time with pressure compensation, which reduction in volume proceeds over the course of a switching movement of the first contact piece 4. Correspondingly, the fluid enclosed in the interior of the compression space 13 is increased in terms of its pressure and, in the process, in particular forced outwards continuously through the outflow channels 14a, 14b, 14c. Owing to the cross sections of the outflow channels 14a, 14b, 14c, an acceleration of the fluid passing through takes place, and the fluid compressed in the compression space 13 flows into the isolation zone 12. Once the first contact piece 4 has been released by the main contact section 5a of the second contact piece 5, a galvanic contact with the preliminary contact section 5b remains. The preliminary contact section 5b is pressed, spring-loaded, against the first contact piece 4 which is moving further away. Only when a stop is reached, i.e. when the preliminary contact section 5b stops (bush opening in the second contact piece 5 is closed), does the remaining current path open and the fluid flow emerging from the outflow openings of the outflow channels 14a, 14b, 14c is flushed around an arc which may be struck, already at this point in time. A centrally arranged channel 14b is in this case damped by the preliminary contact section 5a until a galvanic connection between the first and the second contact pieces 4, 5 is provided. Below the longitudinal axis 6, an intermediate position of the first contact piece 4 is depicted, in which the first contact piece 4 is brought from its closed position into its open position, wherein galvanic isolation of the two contact pieces 4, 5 has already taken place, but the end position of the first contact piece 4 has not yet been reached. At this point in time, an increased pressure in the interior of the compression space can be observed (cf. density of the particles shown symbolically in the compression space 13 above or below the longitudinal axis 6).

1-8. (canceled)

9. An isolating switching device, comprising:
an isolation zone;
a first contact piece and a second contact piece being movable relative to one another and configured to be isolated in said isolation zone; and
a compression device having a compression space for accommodating a fluid;
said first contact piece having at least one outflow opening for emergence of the fluid compressed in said compression space.

10. The isolating switching device according to claim 9, wherein said compression space at least temporarily protrudes at least partially into said isolation zone.

11. The isolating switching device according to claim 9, wherein said compression space is at least partially delimited by said first contact piece.

12. The isolating switching device according to claim 9, wherein said compression space is encompassed by said first contact piece.

13. The isolating switching device according to claim 9, wherein said first contact piece has a contact-making region, and said at least one outflow opening for the fluid compressed in said compression space includes an outflow opening disposed in said contact-making region.

14. The isolating switching device according to claim 9, which further comprises:
a piston or cylinder being movable relative to said first contact piece; said first contact piece acting as a cylinder or as a piston for said piston or cylinder being movable relative to said first contact piece.

15. The isolating switching device according to claim 9, wherein said second contact piece has a preliminary contact section and a main contact section.

16. The isolating switching device according to claim 15, wherein said preliminary contact section and said main contact section are movable relative to one another.

17. The isolating switching device according to claim 9, wherein the fluid compressed in said compression space flows out of said compression space during a switch-off operation.
